(19) United States
(12) Patent Application Publication
(10) Pub. No.: US 2013/0086164 A1
(43) Pub. Date: Apr. 4, 2013

(54) Automobile social networking

(71) Applicants: Jeffrey D. Wheeler, Dana Point, CA (US); Nambirajan Seshadri, Irvine, CA (US)

(72) Inventors: Jeffrey D. Wheeler, Dana Point, CA (US); Nambirajan Seshadri, Irvine, CA (US)

(73) Assignee: BROADCOM CORPORATION, Irvine, CA (US)

(21) Appl. No.: 13/326,113

(22) Filed: Dec. 14, 2011

Related U.S. Application Data
(60) Provisional application No. 61/541,805, filed on Sep. 30, 2011.

(51) Int. Cl. G06F 15/16; H04W 8/00

(52) U.S. Cl. 709/204

(57) ABSTRACT

A technique to identify vehicles proximal in distance to a user's vehicle travelling on a road, transmit wirelessly to the vehicles an inquiry to attempt to communicate with one of the vehicles and when a response is received in the affirmative from an intended target vehicle, adding the intended target vehicle to a social networking group. The user then establishes a wireless communication link between the user's vehicle and the responding target vehicle to conduct vehicle-to-vehicle wireless communication between the user and an occupant in the responding target vehicle. Subsequently, other vehicles may be added to the social networking group to provide a platform for conducting conversations and information exchange among the social networking group.

### CROSS REFERENCE TO RELATED APPLICATION

The present U.S. Utility Patent Application claims priority pursuant to 35 U.S.C. §119(e) to U.S. Provisional Patent Application Ser. No. 61/541,805, entitled “Automobile Social Networking”, having a provisional filing date of Sep. 30, 2011, pending, which is hereby incorporated herein by reference in its entirety and made part of the present U.S. Utility Patent Application for all purposes.

### BACKGROUND OF THE INVENTION

1. Technical Field of the Invention

The embodiments of the invention relate to wireless vehicle-to-vehicle (or car-to-car) communications and, more particularly, to providing a social grouping or networking of vehicles that are travelling within a close proximity to a user's vehicle.

2. Description of Related Art

With the proliferation of wireless communication devices, automobile manufacturers are now implementing many types of communication devices in automobiles. Automobiles now incorporate navigation devices that utilize GPS (Global Positioning System) technology to aid in navigating the vehicle, as well as identifying the locations of points of interest (e.g. hotels, restaurants, movie theaters, etc.). Some automobiles are linked through satellite connections so that the occupants of the vehicle can communicate with a monitoring service for aid in the event of an emergency or accident. Some even provide concierge service to pamper the driver. Many automobiles now also incorporate Bluetooth™ technology to tie in the driver's mobile (cellular) phone, so that hands-free operation of the mobile phone is possible with Bluetooth controls on or near the steering wheel of the vehicle for easy operation. Some cars are now capable of having Internet connections, so that passengers may connect to search the World Wide Web (WWW) or download movies, television shows, etc.

Aside from these navigational or entertainment oriented technologies, automobile manufacturers are now responding to developing various other communications between vehicles or between a vehicle and an infrastructure. Vehicle-to-vehicle (V2V) communication, also referred to as car-to-car (C2C) communication, as well as infrastructure-to-vehicle communication, are being developed as part of vehicle infrastructure integration, in order to transfer information between vehicles or between vehicles and an infrastructure. Such developments allow manufacturers to obtain various vehicle diagnostics, including such things as performance characteristics, driver response, identification of defects, etc. The V2V communication technology is being experimented with to collect and relay information that pertain to road conditions, emergency situations, etc., in order to identify and warn drivers of impending road hazards or other conditions. The V2V communication technology also allows emergency services, such as police vehicles, to alert other vehicles on the road to clear a path for the emergency vehicle. Other V2V communication technologies are also being developed to provide information between vehicles for such things as reducing traffic congestion, improving traffic efficiency, avoiding hazards and accidents, and providing helpful or business information to the occupants of a travelling vehicle.

Government agencies and automobile manufacturers are developing various technologies in the V2V communication area, most deal with collecting and sharing data for the purposes of improving traffic flow, assisting the driver or collecting information relating to the vehicle. It would be advantageous to develop a V2V communication where the communication is between or among drivers who are driving on the road. By establishing a communication link between proximal vehicles on a road, a driver-to-driver exchange may take place to pass on information or just to enjoy a passing conversation.

Accordingly, a need exists to provide for a social networking group of drivers who are within proximal vicinity of each other to utilize vehicle-to-vehicle communication to pass information or to carry on a conversation.

### BRIEF DESCRIPTION OF THE DRAWINGS

FIG. 1 is a diagram showing an application of vehicle-to-vehicle communication among vehicles on a road in accordance with one embodiment for practicing the invention.

FIG. 2 is a pictorial diagram showing a dash mounted navigation display screen to identify cars on the road for establishing a communication links in accordance with one embodiment for practicing the invention.

FIG. 3 is an illustration showing an enlargement of the navigation screen of FIG. 2 in accordance with one embodiment for practicing the invention.

FIG. 4 illustrates the use of direct vehicle-to-vehicle communication links for providing vehicle-to-vehicle communication in accordance with one embodiment for practicing the invention.

FIG. 5 illustrates the use of a control point, access point, or Node B to provide indirect vehicle-to-vehicle communication in accordance with one embodiment for practicing the invention.

FIG. 6 is a diagram showing an extension of the road of FIG. 1, in which vehicles relay signals to extend the range for vehicle-to-vehicle communication in accordance with one embodiment for practicing the invention.

FIG. 7 is a pictorial diagram showing a navigation screen in accordance with one embodiment for practicing the invention, in which an enlarged map is displayed on the screen showing another member of a social group at more than a proximal distance from the user's car.

FIG. 8 is a flow diagram showing a method for initiating vehicle-to-vehicle communication and establishing of a social networking group of vehicles travelling on a road in accordance with one embodiment for practicing the invention.

FIG. 9 is a flow diagram showing a method for receiving vehicle-to-vehicle communication from another vehicle and accepting inclusion into a social group of vehicles travelling on a road in accordance with one embodiment for practicing the invention.

FIG. 10 is a circuit block diagram showing one hardware implementation to provide vehicle-to-vehicle communication in accordance with one embodiment for practicing the invention.

### DETAILED DESCRIPTION OF THE INVENTION

The embodiments of the present invention may be practiced utilizing a variety of wireless communication protocols and/or standards to communicate between vehicles and/or communication between a vehicle and a control point (or access point). One protocol discussed herein to effect the wireless communication is 802.11 (IEEE 802.11, also commonly referred to as WiFi). Another common protocol is Bluetooth™. The communication link need not be limited to 802.11 or Bluetooth technology. In some embodiments, cellular connections may be used, such as when indirect communication utilizing a control point. For example, Node B of current cellular technology may be called upon to provide indirect vehicle-to-vehicle communication. In other embodiments, radio frequency signals, other than 802.11, or laser signals may be used to provide the communication link between vehicles. Collectively these will be referred to as “wireless” communication technologies. Thus, it is to be noted that the invention is not limited to a particular protocol or standard, nor to how the protocol/standard is implemented.

Furthermore, the description below refers to both vehicles and cars. It is understood that vehicles and cars are used interchangeably herein. The wireless communication between vehicles may be practiced with various vehicles, including, automobiles, trucks, motorcycles, etc., and generally refer to any vehicle that travels on a road or highway.

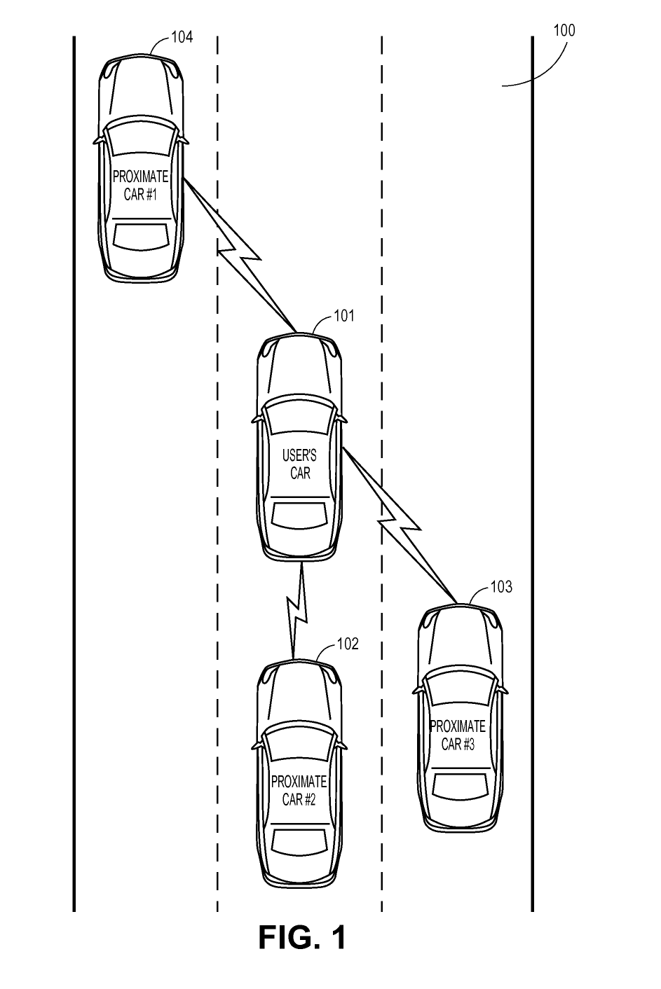

FIG. 1 depicts an example of a real world road (or highway) situation in which multiple cars are travelling on a road 100. Four cars 101, 102, 103, 104 are shown in the example, in which a particular user of the below described system resides in car 101 (identified as user's car). The other three cars 102-104 are noted as proximate cars #1, #2 and #3. Cars 102-104 are noted as proximate, since the proximal distance of these cars to the user's car allow the user to communicate wirelessly utilizing vehicle-to-vehicle (V2V) communication.

Wireless V2V communication between cars may be achieved utilizing any of a variety of wireless communication techniques, including currently known techniques, provided the cars that are communicating are properly equipped to transmit and receive wireless communication and are using a communication protocol (or standard) that allows them to communicate with each other. For example, the cars may utilize currently implemented 802.11 protocols (such as 802.11 a/b/g/n) to establish the communication links. Current wireless local area network (WLAN) techniques (e.g. WiFi, Bluetooth™, etc.) may be adapted to provide the communication links between user's car 101 and one or more other cars 102-104. As an example, user's car 101 may operate as an access point (AP), while other cars (when equipped) may operate as station (STA) devices. Alternatively, the communication link between user's car and other cars may operate as peer-to-peer links.

The communication link need not be limited to the use of 802.11 technology. Other communication technologies and protocols may be implemented. For example, one of the current V2V communications being implemented by the automobile manufacturers may be readily adapted to provide the link between user's car 101 and the other cars.

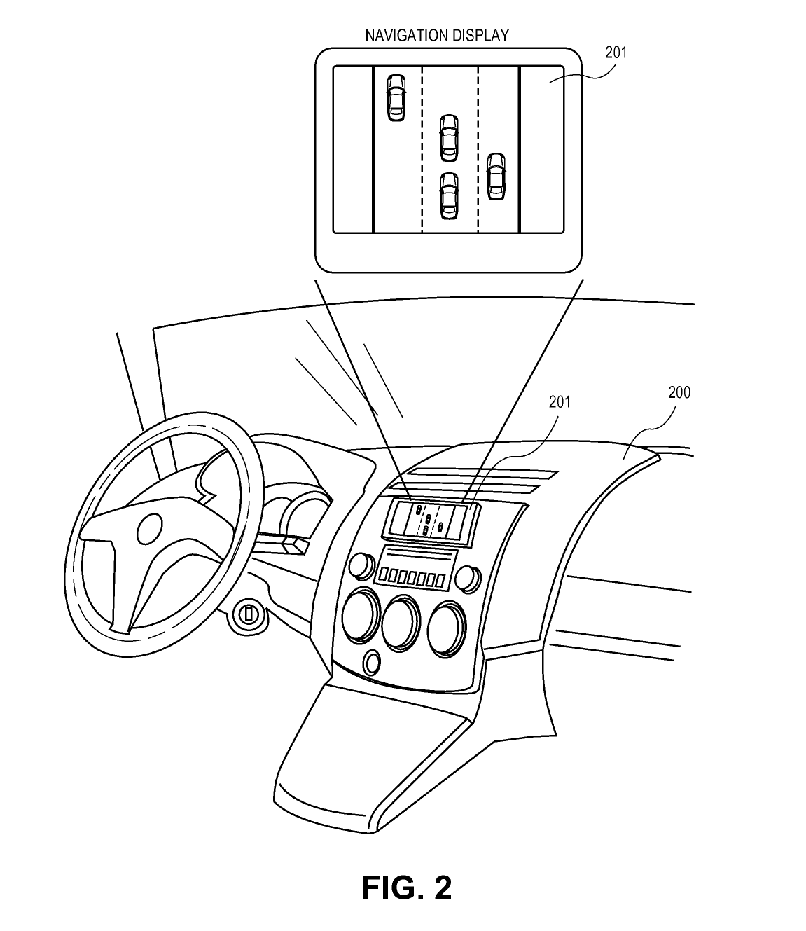

FIG. 2 illustrates an example of a dash console 200 of user's car 101, in which a navigation display screen 201 shows cars travelling along the road, including the user's car. The illustration of the navigation display of FIG. 2 shows the arrangement of the cars shown in FIG. 1. It is noted that display screens are commonplace in current generation cars, in which the display screen may be switched to provide one or more various displays, such as displaying vehicle operating parameters, displaying radio stations, displaying images from a back-up camera, displaying a navigation screen (such as a GPS display), displaying counter-measures (such as speed traps and traffic cameras), etc. In one implementation of the invention, the cars that are proximate to the user's car may be displayed on a display screen, whether using a dedicated screen for this purpose or utilizing a display screen present in the car for one or more of the reasons stated above. That is, in one embodiment, the cars shown in FIG. 1 may be displayed on a display screen according to their relative position on road 100. FIG. 2 illustrates a situation in which navigation display screen 201 shows the relative positioning of the cars.

It is to be noted that the relative positioning of the vehicles for display screen 201 may be obtained by a variety of means. In one technique, once a communication link is established between the user's car 101 and one of the other cars, GPS coordinates may be provided from the other car to give the relative positioning of the other car relative to the user's car. In another technique, newer cars are being equipped with monitoring technology (such as short-range radar) to detect other vehicles that are in vicinity of the transponding vehicle. Accordingly, such devices may be tied into the V2V communication system to allow the user's car 101 to identify and position various vehicles for displaying on display screen 201.

Once the occupant of user's car 101 (hereinafter, noted as user) has a display of the proximate cars, the user may then attempt V2V communication with another car. To initiate the initial dialog with a particular car, the user activates screen 201 to broadcast a V2V communication request to the other proximate cars identifying or attempting to identify the particular car. Screen 201 may be a touch-sensitive screen that includes a touch-screen key board, or voice recognition software (voice-to-text), or some other user interface may be used to broadcast a message to the proximate cars. For example, the user may attempt a communication link by broadcasting a message that states “Greetings black Chevy travelling in lane #3” or some other remark. If a vehicle responds to the initial inquiry, the V2V communication system of the user's car then associates a particular address (such as a media access control address; “MAC” address) to the responding car in establishing a V2V communication link. The user then associates a car on screen 201 with the respondent, effectively associating a particular address to the image on screen 201.

The user may do this with various cars that are within the range of the transmitted signal and identify those respondents by associating a respondent to a unique address. With 802.11 communication technology, this is equivalent to the user's car operating as a defacto access point (AP) and the responding cars operating as stations (STAs). The responding cars are grouped to form a social group, circle or network with respect to the user's car. A car that does not respond to the initial inquiry or declines an invitation to join in communication with the user is not placed within the user's social group.

When the user receives responses from proximate cars to form a social grouping, the user may identify and/or label the various cars noted on screen 201. In one embodiment, screen 201 is a touch-sensitive screen so that when the particular car image is touched, that car's image is highlighted so that a label may be placed on the screen corresponding to that car. A touch-screen keyboard, voice recognition software (voice-to-text), or some other user interface may be used to place a label on screen 210 associated with the cars on the screen.

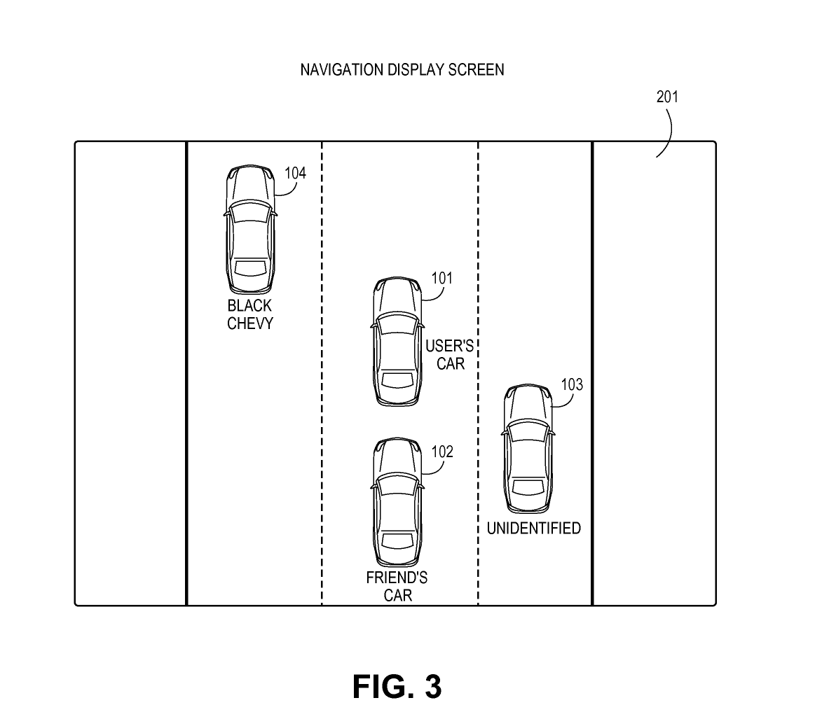

FIG. 3 shows one example of a social grouping formed for user's car 101. The user has labeled car 104 as “Black Chevy” and car 102 as “Friend's car.” Car 103 is labeled “unidentified” since the user did not seek a link with car 103, or the user did seek a link, but did not receive a response. In one embodiment, cars that are not identified have a default “unidentified” label placed on them.

Thus, as shown in the example of FIG. 3, user in car 101 has communicated and received affirmative responses from targeted cars 102 and 104 and have placed both cars 102 and 104 in a social group with car 101. Once the social grouping or networking is achieved, whenever the user wants to communicate with one of the cars in the social group, the user need only touch the image of the particular car on screen 201 (or voice identify the car on the screen) to communicate with that car.

For example, the user can touch the image of car 104 on screen 201 and carry on a conversation and/or send text messaging with the occupants of car 104. Likewise, the user may communicate with friends in car 102. In one embodiment, the various parties in the user's social group may be permitted to participate in a group communication so that all or selected members of the user's social group may communicate together as a group.

In another embodiment, it may be possible for the system that allows location placement of the various cars on the screen to also identify that particular car, such as by its make, model, color, license plate, etc. In that instance, the software or system that allows for the position placement of the cars on screen 201 can also be used to automatically place respective labels on the cars displayed on screen 201 without further user interaction.

In further embodiments, the user's car may not have the system capable of displaying the position of the various cars on a display screen, but still have V2V communication capability. In that instance, a listing of various cars that have V2V communication capability may be listed on a display screen without the visual road display of screen 201. The association of a respondent to user's initial communication to establish a link may be achieved by selecting one of the listed entries, instead of an image of the car on the screen. It is appreciated that other examples abound. The invention allows for particular respondents to be associated with an item on a screen (a list entry, image of a car, etc.), so that item is accepted into a social group established by the user. Once that item is placed into the user's social group, the user need only select that item to communicate with the corresponding vehicle.

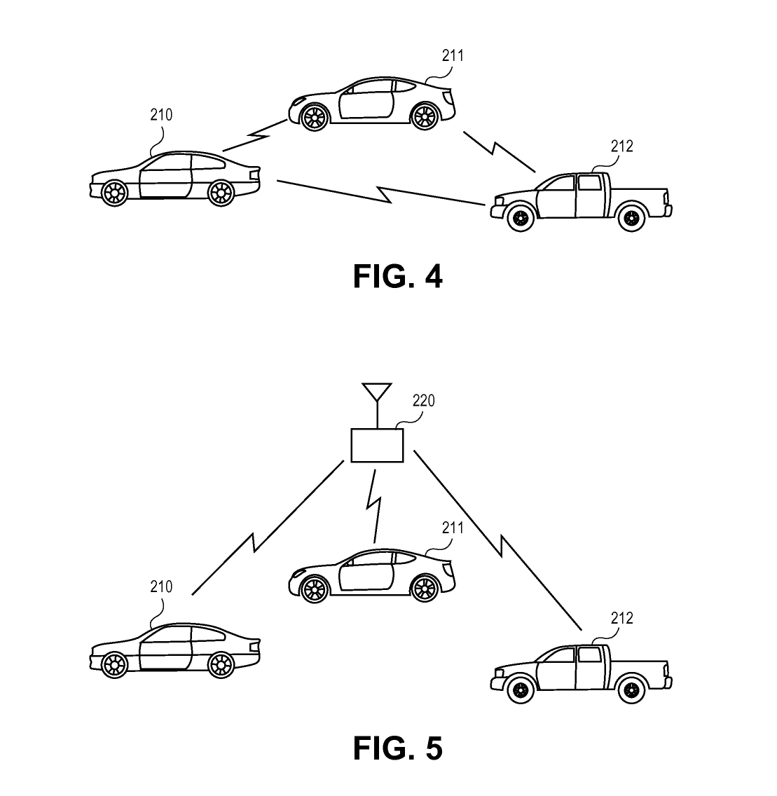

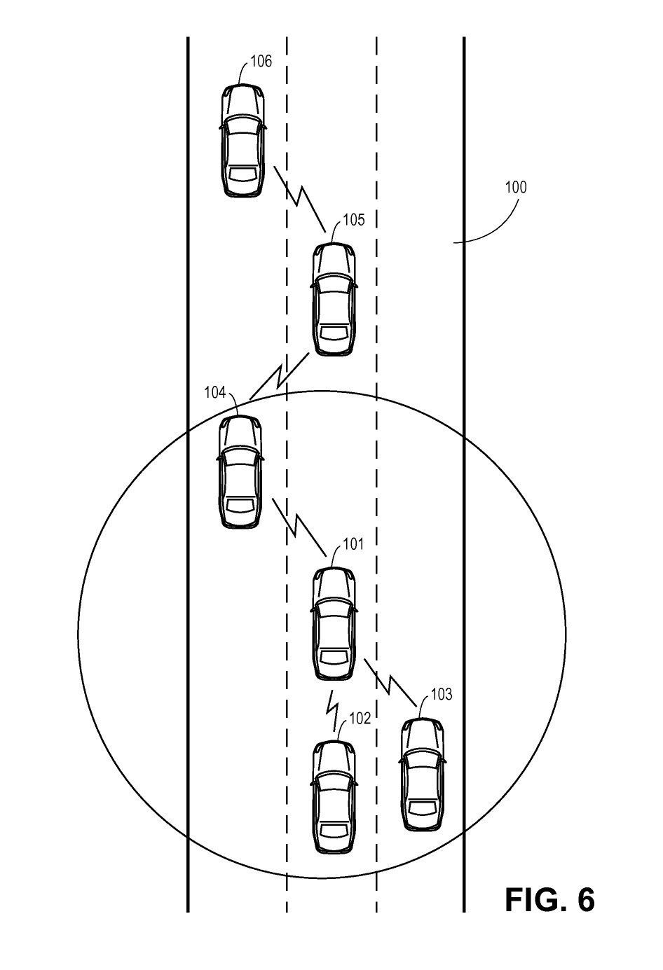

It is to be noted that the V2V communication may be achieved by either a direct communication link between the vehicles as shown in FIG. 4 or indirectly through a network, as shown in FIG. 5. The indirect method utilizes a communication network or infrastructure that the cars link into. The network or infrastructure may utilize different technologies. The connection point is shown as control point 220. If using cellular telephone technology for the communication link, then control point 220 may be Node B of a cellular infrastructure. If using satellite technology, then control point 220 may be a satellite. Accordingly, by using a control point that all vehicles tie into, the V2V communication may be achieved indirectly through a network or infrastructure.

FIG. 6 exemplifies another embodiment for practicing the invention. Generally, when V2V communication is through a network or infrastructure as noted in FIG. 5, the communication range may be extended substantially. It is possible that vehicles that are out-of-sight range may still be in contact with the user through the control point. However, when direct V2V communication is utilized where the communication range is limited between vehicles, such as noted in FIG. 4, cars that are distant may be out of communication range from the user's car. In that event, car-to-car relay may be established to allow communication with cars that are out of proximate range from the user's car.

As shown in FIG. 6, the circle signifies the extent of user's communication range from user's car 101. Cars 102-104 are within this circle and, therefore, directly linked to the user's car. However, cars 105 and 106 are out of range. Assuming that cars 105 and 106 had at one time been proximate to user's car 101 to establish a V2V link and be included within user's social group, these cars still are maintained as part of the social group even when out of range of user's car 101. A chain of links may be established for those cars that are within the social group, provided that a continuous unbroken communication chain may be maintained. Thus, in the example of FIG. 6, car 105 may still communicate with the user's car by maintaining a link through car 104. Likewise, car 106 may still communicate with the user's car by maintaining a link through car 105 and 104. In this manner, a group of cars travelling on a highway once established within a social group may maintain the V2V communication with the user (or alternatively with the group) if a chain of links may be established back to the user's car. Thus, each car in the social group may also operate as a peer-to-peer relay point for communicating within the group.

In another embodiment, when a particular car is out of range of the user's car and no relay link can be established back to the user, that separated car may retain whatever information it intends to send until a link is established again back to the user's car.

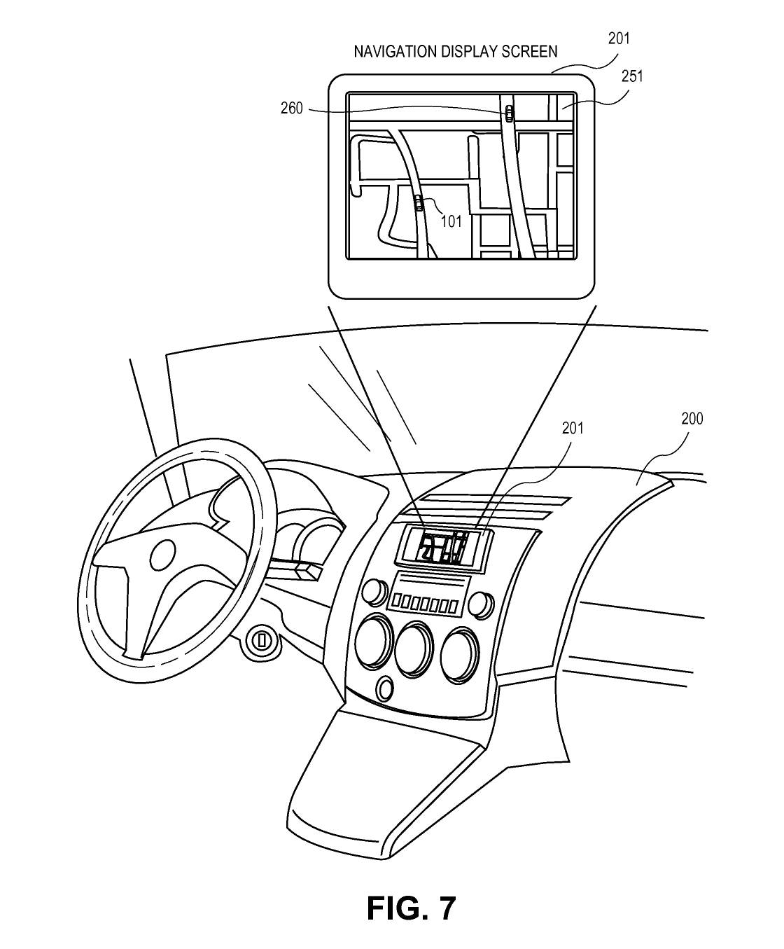

Still, in another embodiment for practicing the invention, a particular car that is out of proximal range of the user's car for direct communication may still be tracked by the user. Whether relying on peer-to-peer relaying technique, indirect communication link through a network (such as described in reference to FIG. 5), or some other technique (such as GPS), the user is able to locate and track a particular car once the car is registered within the social group and is within a certain defined distance from the user's car. For example, as shown in FIG. 7, an image 251 is displayed on screen 201 of the user's car that shows a map of the vicinity of the user's location. The mapping system may be a separate program installed with the user's navigation device or may be tied into a GPS navigation system. As shown on screen 201, user's car 101 is displayed on the map image 251 along with another car 260, which is part of the social group that includes the user. Only one other car 260 is shown, other than user's car 101, but it is understood that other vehicles belonging to the same social group as the user may be displayed as well. In this manner, the user may continue to track the location of another member of the social group. Whenever the user desires to communicate with car 260, the user may initiate contact by utilizing one of the user interaction techniques described above. By having such long range capability, the user may track and communicate with other members of the social group in a larger environment, such as within a large city.

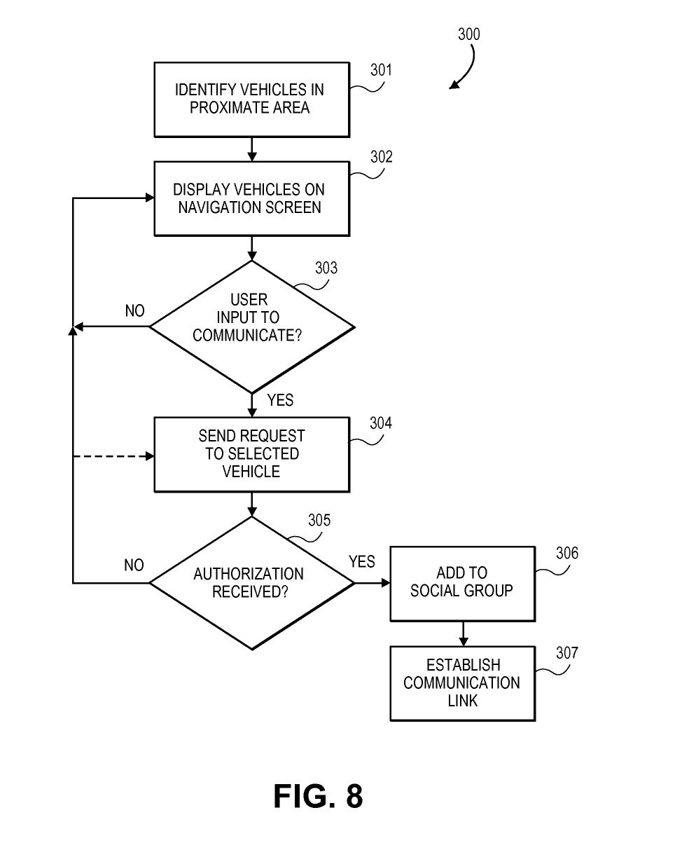

FIG. 8 shows one method 300 for practicing the invention in the user's car as described in the description above. In one embodiment for practicing the invention the example method may be performed by software. As the user's vehicle identifies vehicles in the proximate area (block 301), the vehicles are displayed on the user's navigation screen (block 302). When the user desires to communicate with a certain vehicle, the user inputs commands to communicate with the vehicles (303), at which an inquiry to communicate is sent from the user's vehicle (block 304). If the user receives an authorization to communicate (block 305) from a target vehicle, the user adds the respondent to the user's social group (block 306) and establishes communication with the responding vehicle (block 307).

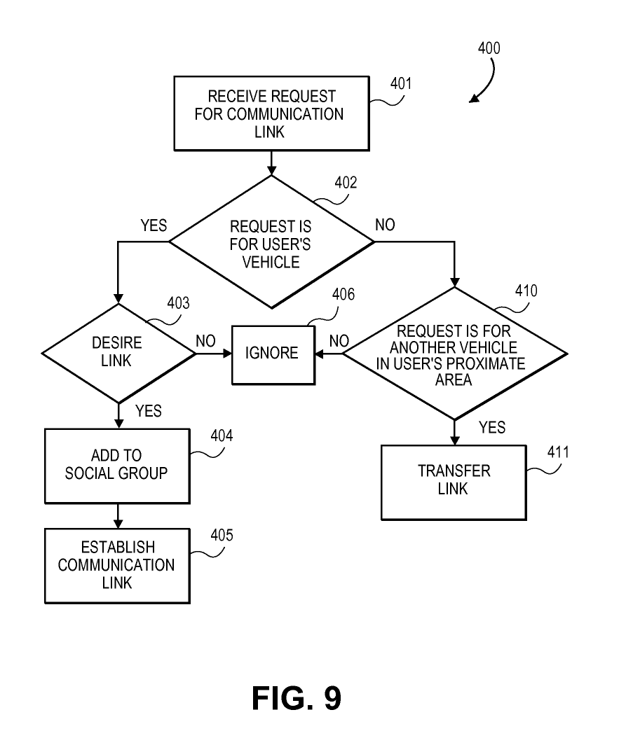

FIG. 9 shows one method 400 for practicing the invention when a user receives a request for communication from another vehicle. If the request is to communicate with the user (block 402), the user may respond in the affirmative (block 403) and be added to the social group of the requesting party, at which point communication link is established to allow communication within the social grouping. If the link is not desired, then the request is ignored (block 406). When communication links are relayed from vehicle to vehicle, so that the request is not for the user's vehicle, but destined for another vehicle within the user's proximate area or relayed through another vehicle within the user's proximate area, the communication link is established to permit a transfer (relay) link to the proximate car (block 410), provided this feature is implemented in the user's car.

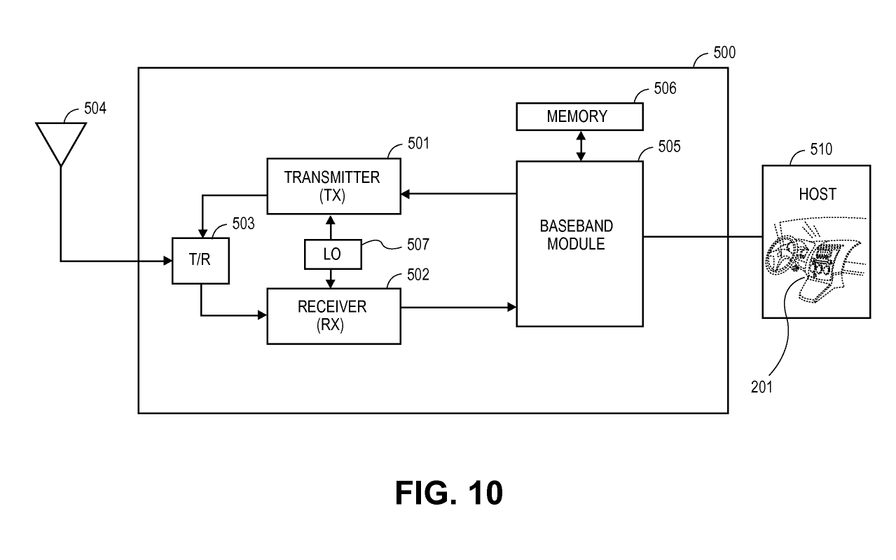

It is to be noted that a variety of devices may be implemented to practice embodiments of the invention. Accordingly, FIG. 10 exemplifies one device that is operable to practice the invention. FIG. 10 is a schematic block diagram illustrating part of a wireless communication device 500 that includes a transmitter (TX) 501, receiver (RX) 502, local oscillator (LO) 507 and baseband module 505. Baseband module 505 provides baseband processing operations. In some embodiments, baseband module 505 is or includes a digital-signal-processor (DSP). Baseband module 505 is typically coupled to a host module 510, applications processor or other unit(s) that provides operational processing for the device and/or interface with a user. In this instance, host module 510 represents the computing portion that also includes the display screen 201 described above.

A memory 506 is shown coupled to baseband module 505. The memory 506 may be utilized to store data, as well as program instructions that operate on baseband module 505. Various types of memory devices may be utilized for memory 506. It is to be noted that memory 506 may be located anywhere within device 500 and, in one instance, it may also be part of baseband module 505.

Transmitter 501 and receiver 502 are coupled to an antenna 504 via transmit/receive (T/R) switch module 503. T/R switch module 503 switches the antenna between the transmitter and receiver depending on the mode of operation. In other embodiments, separate antennas may be used for transmitter 501 and receiver 502, respectively. Furthermore, in other embodiments, multiple antennas or antenna arrays may be utilized with device 500 to provide antenna diversity or multiple input and/or multiple output, such as MIMO, capabilities.

Outbound data for transmission from host module 510 are coupled to baseband module 505 and converted to baseband signals and then coupled to transmitter 501. Transmitter 501 converts the baseband signals to outbound radio frequency (RF) signals for transmission via antenna 504. Transmitter 501 may utilize one of a variety of up-conversion or modulation techniques to convert the outbound baseband signals to outbound RF signal. Generally, the conversion process is dependent on the particular communication standard or protocol being utilized.

In a similar manner, inbound RF signals are received by antenna 504 and coupled to receiver 502. Receiver 502 then converts the inbound RF signals to inbound baseband signals, which are then coupled to baseband module 505. Receiver 502 may utilize one of a variety of down-conversion or demodulation techniques to convert the inbound RF signals to inbound baseband signals. The inbound baseband signals are processed by baseband module 505 and inbound data is output from baseband module 505 to host module 510.

LO 507 provides local oscillation signals for use by transmitter 501 for up-conversion and by receiver 102 for down-conversion. In some embodiments, separate LOs may be used for transmitter 501 and receiver 502. Although a variety of LO circuitry may be used, in some embodiments, a PLL is utilized to lock the LO to output a frequency stable LO signal based on a selected channel frequency.

It is to be noted that in one embodiment, baseband module 505, LO 507, transmitter 501 and receiver 502 are integrated on the same integrated circuit (IC) chip. Transmitter 501 and receiver 502 are typically referred to as the RF front-end. In other embodiments, one or more of these components may be on separate IC chips. Similarly, other components shown in FIG. 9 may be incorporated on the same IC chip, along with baseband module 505, LO 507, transmitter 501 and receiver 502. In some embodiments, the antenna 504 may also be incorporated on the same IC chip as well. Furthermore, with the advent of system-on-chip (SOC) integration, host devices, application processors and/or user interfaces, such as portions of host module 510, may be integrated on the same IC chip along with baseband module 505, transmitter 501 and receiver 502.

Additionally, although one transmitter 501 and one receiver 502 are shown, it is to be noted that other embodiments may utilize multiple transmitter units and receiver units, as well as multiple LOs. For example, diversity communication and/or multiple input and/or multiple output communications, such as multiple-input-multiple-output (MIMO) communication, may utilize multiple transmitters 501 and/or receivers 502 as part of the RF front-end.

Wireless communication device 500 may be incorporated within a vehicle to provide the various functions noted in the above description. Device 500 may be utilized to provide the RF communication utilizing various protocols and standards and may be operable for 802.11 communication, Bluetooth communication, cellular communication, satellite communication, etc.

Accordingly, various embodiments of the invention may be practiced to provide for automobile social networking in which members of the social network may communicate to converse, share information and generally provide a social environment for occupants when travelling in a vehicle. The social gathering may be expanded to have multiple groupings, and may represent functions somewhat akin to Facebook™-like page for social communication. The occupants of vehicles in a social network may share point-of-interest communication between cars while travelling. For example, those travelling to an antique show or to a sporting event can chat as a group when travelling. In some embodiments, sub social grouping may be generated from the main social grouping. The examples are numerous and not bounded by the description herein.

Furthermore, it is to be noted that the user may set up more than one social group and/or join more than one social group established by another car. For example, the user may set one social group for the user's car that encompasses friends and acquaintances. Another may be for work associates. Still another may be for strangers contacted on the road. When travelling, the user may readily change display images based on the particular social group. Alternatively, all of the user's social groups may be displayed together on the screen, but groups may be differentiated by having the car images displayed in colors corresponding to the particular social group. Likewise, when the user joins social group(s) of other cars, those groupings may be displayed in similar manner as well.

In one such technique, the user may establish a social group that is dependent on other factors and not based on the status of the occupant of another car. For example, the user may establish a social group that profile other cars of the same manufacturer, model or type of car. For example, a profile may be set by the user to group those cars of the same make and model. Thus, in this social group, cars of the same make/model are identified and accepted into the group. Likewise, the user may be invited to join such a group established by another car. This social grouping allows the user to discuss various attributes related to the particular make/model. In one embodiment, this grouping allows the user to share information about the car with members of the social group, including the communication of various diagnostic information about the particular make and model with other members of the group. The diagnostic information may be verbal or written communication amongst the members of the group, or it may be the transfer of diagnostic data retained by the car's diagnostic electronics. Such diagnostic data may be displayed on the screen or retained in storage for future use.

As an example, another profile group may be established for cars of a certain vintage, such as antique cars, sports cars, recreational vehicles, etc. Many other varieties of social groups may be established within the framework for practicing the invention. Similarly, the manner in how the various groups or sub-groups may be organized or displayed is a design choice and may take many forms. For example, Facebook-like profile or profiles may be utilized and displayed to allow the user to participate in group social networking in a car.

Accordingly, a technique to provide automobile social networking is described.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While particular combinations of various functions and features of the present invention have been expressly described herein, other combinations of these features and functions are likewise possible. The present invention is not limited by the particular examples disclosed herein and expressly incorporates these other combinations.

We claim:

1. A method comprising:
identifying vehicles proximal in distance to a user's vehicle;
transmitting an inquiry to attempt to communicate with at least one of the proximal vehicles, the inquiry being directed to a target vehicle;
receiving an affirmative response to communicate from the target vehicle;
adding the target vehicle to a social networking group;
establishing a wireless communication link between the user's vehicle and the responding target vehicle in the social networking group; and
conducting vehicle-to-vehicle wireless communication between the user and an occupant in the responding target vehicle.

2. The method of claim 1, wherein establishing the wireless communication link is established directly between the user's vehicle and the target vehicle.

3. The method of claim 1, wherein establishing the wireless communication link is established indirectly between the user's vehicle and the target vehicle via a control point of a network or infrastructure.

4. The method of claim 1, further comprising the user establishing communication links with multiple vehicles proximal in distance to the user's vehicle and further adding the multiple vehicles responding to the social networking group.

5. The method of claim 4, further comprising allowing the multiple vehicles in the social networking group to conduct vehicle-to-vehicle wireless communication within the social networking group.

6. The method of claim 5, further comprising displaying the vehicles proximal in distance to the user's vehicle on a display screen, wherein once the social networking group is established, identifying vehicles by selecting a particular identified vehicle on the display screen to thereafter establish communication.

7. The method of claim 6, wherein displaying the vehicles on the display screen shows an image of the vehicles on the road with their positioning relative to the user's vehicle.

8. The method of claim 5, wherein a vehicle that ranges beyond the proximal distance to the user's vehicle continues maintaining the communication link with the user's vehicle by via a relay link with another vehicle in communication distance.

9. The method of claim 1, wherein the communication link utilizes 802.11 protocol to establish and maintain the vehicle-to-vehicle wireless communication.

10. A method comprising:
receiving a wireless vehicle-to-vehicle communication request to join a social networking group of another vehicle travelling on a road, the vehicle being in proximal distance to a user's vehicle also travelling on the road;
responding affirmatively to join the social networking group; and
joining the social networking group to conduct vehicle-to-vehicle wireless communication with the vehicle initiating the social networking group.

11. The method of claim 10, wherein the vehicle-to-vehicle wireless communication is established in a link directly between the vehicles.

12. The method of claim 10, wherein establishing the vehicle-to-vehicle wireless communication is established in a link indirectly between the vehicles via a control point of a network or infrastructure.

13. The method of claim 10, further comprising conducting vehicle-to-vehicle wireless communication with other vehicles in the social networking group.

14. The method of claim 13, further comprising providing a relay link for a vehicle that ranges beyond a proximal distance to the vehicle initiating the social networking group to continue maintaining a communication link between the vehicle initiating the social networking group and the vehicle that ranges beyond the proximal distance.

15. The method of claim 10, wherein the vehicle-to-vehicle communication utilizes 802.11 protocol to establish and maintain the vehicle-to-vehicle wireless communication.

16. An apparatus comprising:
a host module to identify vehicles proximal in distance to a user's vehicle, send an inquiry to attempt to communicate with one of the vehicles, receive a response to communicate from an intended target vehicle of the vehicles proximal in distance to the user's vehicle, add the intended target vehicle to a social networking group when the target vehicle responds in the affirmative to communicate with a user in the user's vehicle; and
a radio frequency transceiver coupled to the host module to establish a wireless communication link between the user's vehicle and the responding target vehicle to conduct vehicle-to-vehicle wireless communication between the user and an occupant in the responding target vehicle.

17. The apparatus of claim 16, wherein the host module communicates with multiple vehicles to enter multiple vehicles into the social networking group and the radio frequency transceiver maintains wireless communication link with the multiple vehicles in the social networking group.

18. The apparatus of claim 17, wherein the vehicle-to-vehicle wireless communication is established in a link directly between the vehicles.

19. The apparatus of claim 17, wherein the vehicle-to-vehicle wireless communication is established in a link indirectly between the vehicles via a control point of a network or infrastructure.

20. The apparatus of claim 17, wherein the host module includes a display screen to displays an image of the vehicles on the road and positioning of the vehicles relative to the user's vehicle.
